(19) United States
(12) Patent Application Publication
(10) Pub. No.: US 2015/0217987 A1
(43) Pub. Date: Aug. 6, 2015

(54) FOOT VALVE FOR SUBMERGIBLE PUMPS

(71) Applicant: Taylor-Wharton Cryogenics LLC, Minnetonka, MN (US)

(72) Inventors: CLAUS EMMER, Prior Lake, MN (US); MATTHEW D. SASSE, Prior Lake, MN (US)

(21) Appl. No.: 14/613,525

(22) Filed: Feb. 4, 2015

Related U.S. Application Data
(60) Provisional application No. 61/935,743, filed on Feb. 4, 2014.

(51) Int. Cl. B67D 7/32; F04D 29/60; B67D 7/68

(52) U.S. Cl. CPC B67D 7/3272; B67D 7/68; F04D 29/608

(57) ABSTRACT

A foot valve assembly for a submergible pump including a substantially open-ended submergible pump housing having an interior volume is disclosed. The foot valve assembly also includes an actuator configured to be operated by pressurized fluid. The foot valve assembly also includes a sealing mechanism positioned at the open end of the submergible pump housing and configured to alter fluid flow into the pump housing. The sealing mechanism is attached to the actuator. The actuator is configured to move the sealing mechanism between a first position and a second position, the first position being a closed position and the second position being an open position.

### CROSS REFERENCE TO RELATED APPLICATIONS

This application claims the benefit of U.S. Provisional Patent Application Ser. No. 61/935,743, filed Feb. 4, 2014, which application is incorporated herein by reference in its entirety.

### BACKGROUND

1. Technical Field

The present disclosure generally relates to a valve mechanism for submergible pumps. More particularly, the present disclosure relates to a foot valve positioned within a cryogenic tank.

2. Related Art

Foot valves have been used in storage tanks as a way to seal the pump housing from the rest of the storage tank. Storage tanks that include foot valves are traditionally designed to include a submergible pump located within a pump housing or conduit. The pump is designed to move stored fluid from the bottom of the storage tank through the pump housing, and to the exterior of the storage tank. The pump and pumping housing can be isolated from the storage tank by a foot valve. By isolating the pump and pump housing from the storage tank, the pump can be removed for maintenance or replacement without having to depressurize or drain the storage tank—a time consuming and often wasteful process.

A variety of foot valves and methods have been disclosed in the prior art. Foot valves that are operated by the weight of the pump are the most common. These foot valves are biased in a closed position against the open end of the submerged pump housing. The foot valve can be held in place by a series of springs attached to the foot valve and the pump housing. When the pump is lowered into the pump housing, the pump contacts with the foot valve and the weight of the pump overcomes the force of the springs. When the springs are overcome, the foot valve is opened, causing the pump housing to become in fluid communication with the storage tank. For example, U.S. Pat. No. 3,963,381 to Kohnen discloses a spring loaded double foot valve that opens using the weight of a pump, which is incorporated herein by reference. In some Liquid Natural Gas (LNG) applications, the shut off of flow of liquid to the pump is often achieved by having a separate pump housing assembly (external to main tank reservoir) with isolation valves.

Improvements and alternatives in pump housing sealing, fire safety, and pump cavitation are desired.

### SUMMARY

One aspect of the present disclosure generally relates a foot valve assembly for a submergible housing. The foot valve assembly includes a substantially open-ended submergible housing having an interior volume. The foot valve assembly also includes an actuator configured to be operated by pressurized fluid. The foot valve assembly also includes a sealing mechanism positioned at the open end of the submergible housing and configured to alter fluid flow into the housing. The sealing mechanism is attached to the actuator. The actuator is configured to move the sealing mechanism between a first position and a second position. The first position being a closed position and the second position being an open position.

Another aspect of the present disclosure also includes a cryogenic tank assembly including a storage container capable of being pressurized and storing fluid, a substantially open-ended submergible pump housing located within the storage container, a pump removably located within the submergible pump housing, and a foot valve assembly mounted to the submergible pump housing. The foot valve assembly includes at least one actuator and a sealing mechanism, the actuator being configured to move the sealing mechanism between a closed position and an open position when pressurized, wherein, when the sealing mechanism is in the closed position, the pump may be removed from the submergible pump housing without altering the pressure of the storage container or draining the fluid stored within the storage container.

A further aspect of the present disclosure includes a foot valve assembly for a submergible pump or other pressurizing device, including a substantially open-ended submergible pump housing, a pump removably positioned within the pump housing, and a sealing mechanism mounted at the open end of the submergible pump housing for sealing the pump housing, wherein the sealing mechanism is operated by the weight of the pump. The foot valve assembly further includes an actuator movable by pressurized fluid, wherein the actuator is connected to the pump, and wherein the sealing mechanism is in the closed position when the actuator is not pressurized.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic drawing of a cryogenic tank including a foot valve assembly according to one embodiment of the present disclosure;

FIG. 2 is a schematic drawing of a pump housing assembly according to one embodiment of the present disclosure;

FIG. 3 is a schematic drawing of the lower pump housing assembly of the pump housing assembly of FIG. 2, according to one embodiment of the present disclosure;

FIG. 4 is a schematic drawing of the upper pump housing assembly of the pump housing assembly of FIG. 2, according to one embodiment of the present disclosure;

FIG. 5 is a schematic drawing of a pump housing assembly according to one embodiment of the present disclosure;

FIG. 6 is a schematic diagram illustrating a foot valve according to one embodiment of the present disclosure;

FIG. 7 is a schematic diagram illustrating the foot valve within a storage tank according to one embodiment of the present disclosure; and

FIG. 8 is a schematic drawing illustrating a mobile fuel dispensing system, according to one embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure applies generally to cryogenic systems that utilize a submerged pump, or other types of liquid storage systems that are in need of an in-tank valve or shut-off device. The most immediate application is in liquid natural gas (LNG) storage systems, where the ability to shut off the flow of liquid within the tank meets and exceeds the safety requirements and standards that are required of such LNG systems.

The present disclosure relates to a powered fail-closed foot valve that can operate immersed in an LNG storage tank and, when in the closed position, seal off the inlet of a submerged pump housing from the storage tank. In one embodiment, to remove the seal between the pump housing and storage tank, the foot valve mechanism can be energized, preferably by pressure, to effectively unseal the pump housing from the storage tank. In some embodiments, the submerged pump housing can be isolated from the storage tank without venting the tank to the atmosphere or draining any fluid from the tank. The present disclosure provides for an improved method to repair or exchange a submerged pump that is used to pump LNG into vehicles or other storage tanks. Additionally, the present disclosure is designed to also work in pressurized systems or environments.

There are several aspects of the present disclosure. First, the foot valve of the present disclosure acts as an internal isolation valve to allow for easy servicing of submerged pumps or other devices that may be required to be submerged inside a cryogenic storage tank for operation.

Second, the foot valve is a fail-closed valve positioned inside the storage tank, at the first point of entry of the liquid into the pump housing. This meets the requirements of internal excess flow valves required by some jurisdictions, such as Australia, and better meets the requirements of U.S. codes such as National Fire Protection Association (NFPA) 59A and 52 that require fail-closed isolation valves on LNG tanks. Additionally, this is important for the safety of the storage tank in the event the storage tank experiences external damage.

Third, the foot valve can also be utilized in other types of mobile equipment that need a protected method of shutting off the flow of LNG—such as boat/marine applications, railcars, LNG trailers, etc. Accordingly, the foot valve can be tailored or customized for any number of different flow rate requirements while offering little or no liquid pressure resistance prior to entrance to the pumping device.

Fourth, the foot valve may be fitted to variety of differently sizing pump housings to accommodate a variety of pumps and other equipment.

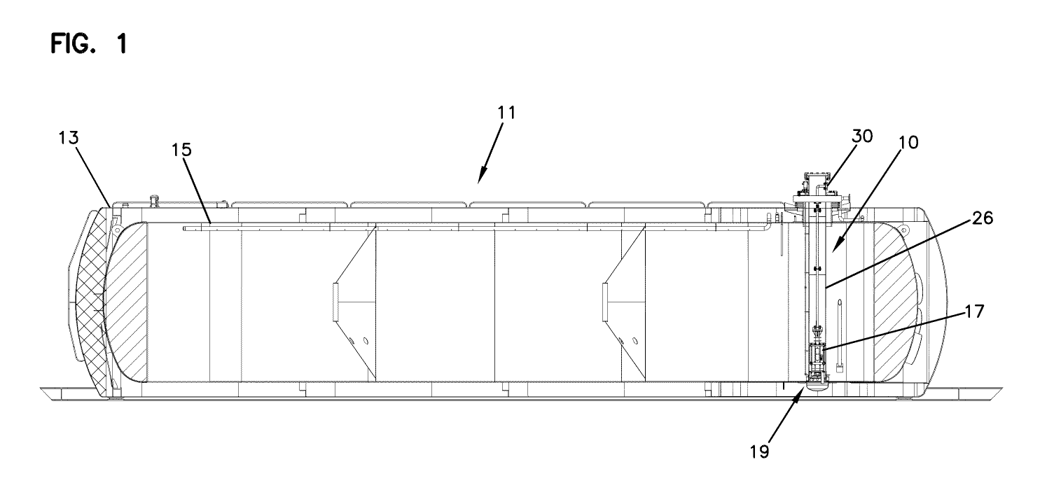

FIG. 1 shows a schematic cross-section side view of an example cryogenic tank 11, specifically an LNG tank. The tank 11 includes an outer jacket 13 surrounding an inner tank 15. In some embodiments, a variety of different transportation features (i.e. a skid, skids, or attachment hooks) can be secured to the outer jacket 13. In some embodiments, the tank 11 may be manufactured to be safely transported via truck or train, or, alternatively, safely buried underground. The tank 11 includes pump housing assembly 10 that includes a single access point 30, shown located in the top of the tank 11. In some embodiments, the access point 30 is located near or on the side of the tank 11. The pump housing assembly 10 provides access to the inner tank 15 and can include a pump housing 26, a removable pump 17, with its accompanying plumbing, and a foot valve assembly 19. The removable pump 17 provides a way of removing fluid stored within the inner tank 15. In some embodiments, the removeable pump 17 is removed from the pump housing assembly and a different pressurizing device can be utilized to remove fluid from the storage tank.

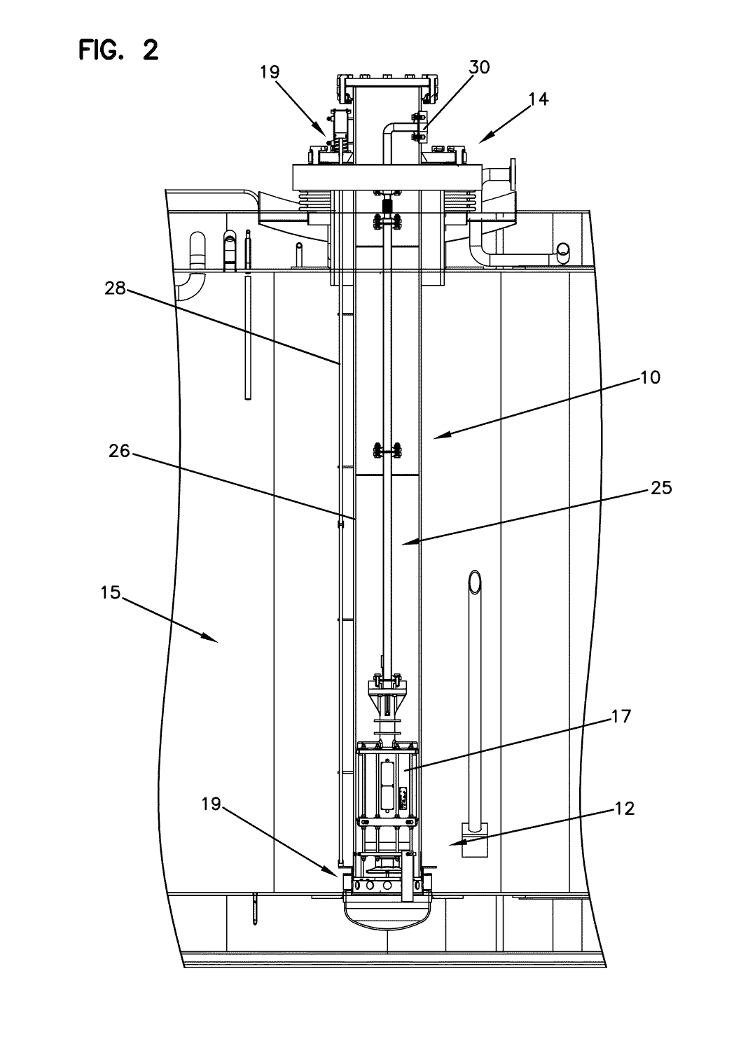

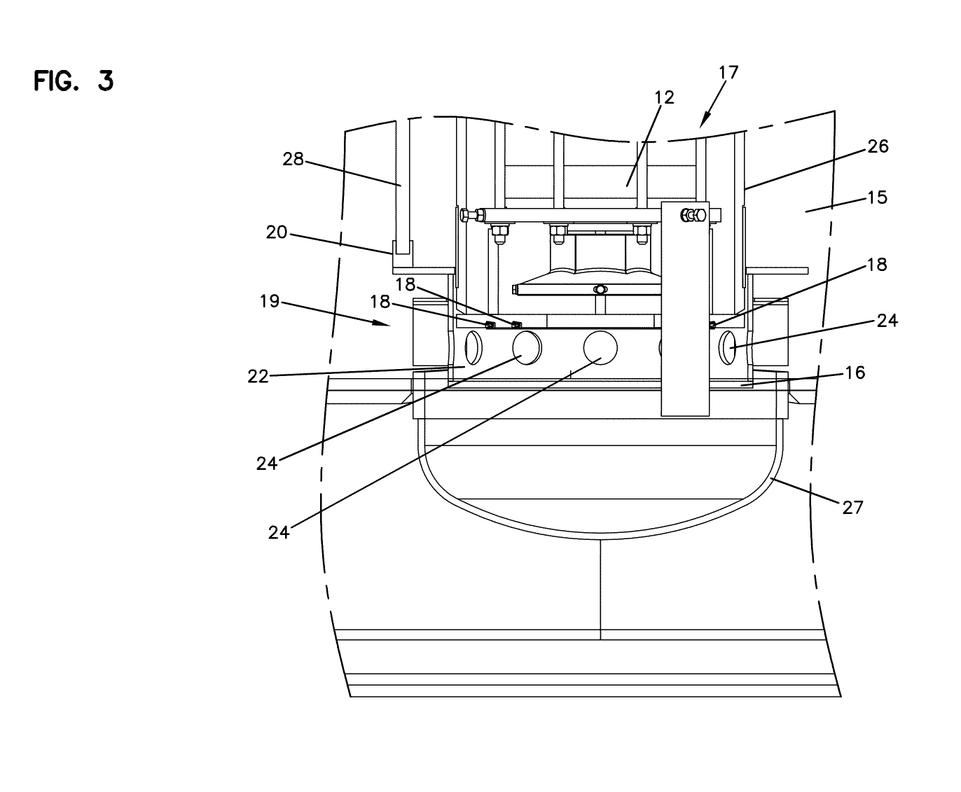

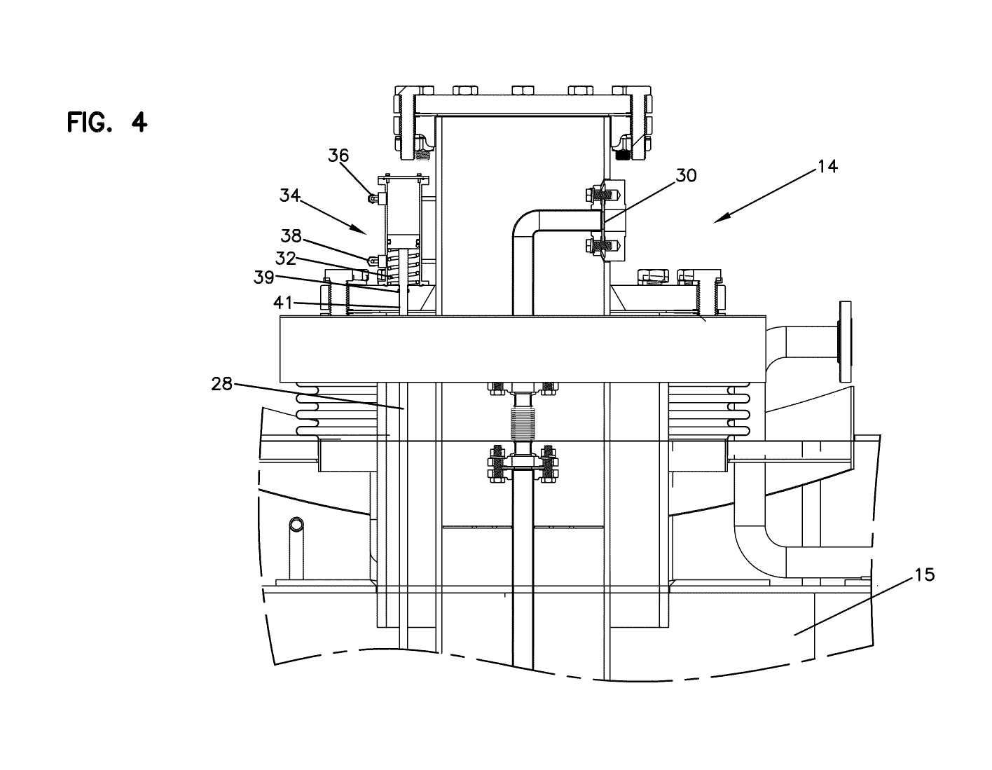

FIG. 2 shows a schematic side view of the pump housing assembly 10 of FIG. 1. The pump housing assembly 10, as shown, includes a lower pump housing assembly 12, an upper pump housing assembly 14, a pump housing 26, and an interior portion 25. The lower pump housing assembly 12 is shown in more detail in FIG. 3, and the upper pump housing assembly 14 is shown in more detail in FIG. 4.

The lower pump housing assembly 12 is configured to include a portion of the foot valve assembly 19. In addition, when installed, the pump 17 rests near the lower pump housing assembly 12. The foot valve assembly 19 is movable between an open position and a closed position. In some embodiments, the foot valve assembly is moveable independently of the pump's 17 position within the pump housing 26. In the depicted embodiment, the foot valve assembly 19 is operable even when the pump housing 26 does not contain a pump 17. In the open position, the foot valve assembly 19 allows for fluid communication between the interior portion 25 of pump housing assembly 10 and the inner tank 15. In the closed position, the foot valve assembly 19 prevents fluid communication between the interior portion 25 of the pump housing assembly 10 and the inner tank 15.

The upper pump housing assembly 14 includes the access point 30 to the pump housing assembly 10. The upper pump housing assembly 14 also includes a portion of the foot valve assembly 19. The foot valve assembly 19 includes an actuator 28 that connects the portion of the foot valve assembly at the upper pump housing assembly 14 with the portion of the foot valve assembly 19 at the lower pump housing assembly 12. The actuator 28 is configured to facilitate movement of the foot valve assembly 19 between the open and closed positions.

FIG. 3 shows a side schematic view of the lower pump housing assembly 12, specifically the foot valve assembly 19. The foot valve assembly 19 is depicted in the open position. The lower pump housing assembly 12 includes a sealing plate 16, a seal 18, an actuator sleeve 20, and a basket 22 that includes openings 24. In the depicted embodiment, the lower pump assembly 12 is positioned proximate to a sump 27 of the inner tank 15.

The sealing plate 16 is configured to make contact with the pump housing 26 to seal off the interior portion 25 of pump housing assembly 10 from inner tank 15 when the foot valve assembly 19 is in the closed position. When the foot valve assembly 19 is in the open position (i.e. when the sealing plate 16 is not in contact with the pump housing 26), the basket 22 allows a flow of fluid from inner tank 15 to the pump 17 to ensure that there is no pump starvation or cavitation. In one embodiment, the sealing plate 16 can make contact with the seal 18 when in the closed position.

Additionally, in some embodiments, the sealing plate 16 can have a polished surface to ensure a strong seal against the seal 18. The sealing plate 16 can be of a variety of thicknesses depending on the specific application and pressure within the storage tank 11. Proper thickness will minimize deformation. Alternatively, the sealing plate 16 can be reinforced to reduce deformation. In other embodiments, the sealing plate 16 can be made of a cryogenic rated material, like stainless steel, to allow for ease of polishing. In still other embodiments, the sealing plate 16 may take a variety of shapes. These shapes could include, but are not limited to, a cone, a hemisphere, or some other self-centering geometric solid. Also in some embodiments, the sealing plate 16 can be attached to a basket 22.

The seal 18 is configured to provide a liquid tight seal between the sealing plate 16 and the pump housing 26. In some embodiments, the seal 18 may be a single continuous seal. In the depicted embodiment, the seal 18 includes a plurality of seals 18. In the closed position, the sealing plate 16 can rest against the plurality of seals 18 which are located on the lower part of the pump housing 26. In some embodiments, the seals are spring energized. In other embodiments, the seals are O-rings. In still other embodiments, the seals 18 are static seals designed for LNG/cryogenic service. The seals 18 can be made of an elastomer that retains some flexibility at cryogenic temperatures, such as Teflon®, Kevlar®, Kel-F®, Nylon®, etc. When in the closed position, the higher the pressure in the inner tank 15, the harder the sealing plate 16 will be pressed against the seals 18. This is especially true if the interior portion 25 of pump housing assembly 10 is de-pressurized. In some embodiments, the seal 18 can be located on the sealing plate 16 itself.

In the depicted embodiment, the sealing plate is integral to the basket 22. The basket 22 includes a plurality of openings 24 to allow for fluid communication between the interior portion 25 of pump housing assembly 10, specifically the pump 17, and inner tank 15. In some embodiments, the basket 22 includes a mesh filter (not shown). The mesh filter is configured to filter any debris from the LNG contained within the inner tank 15 prior to the LNG entering the inlet of the pump 17.

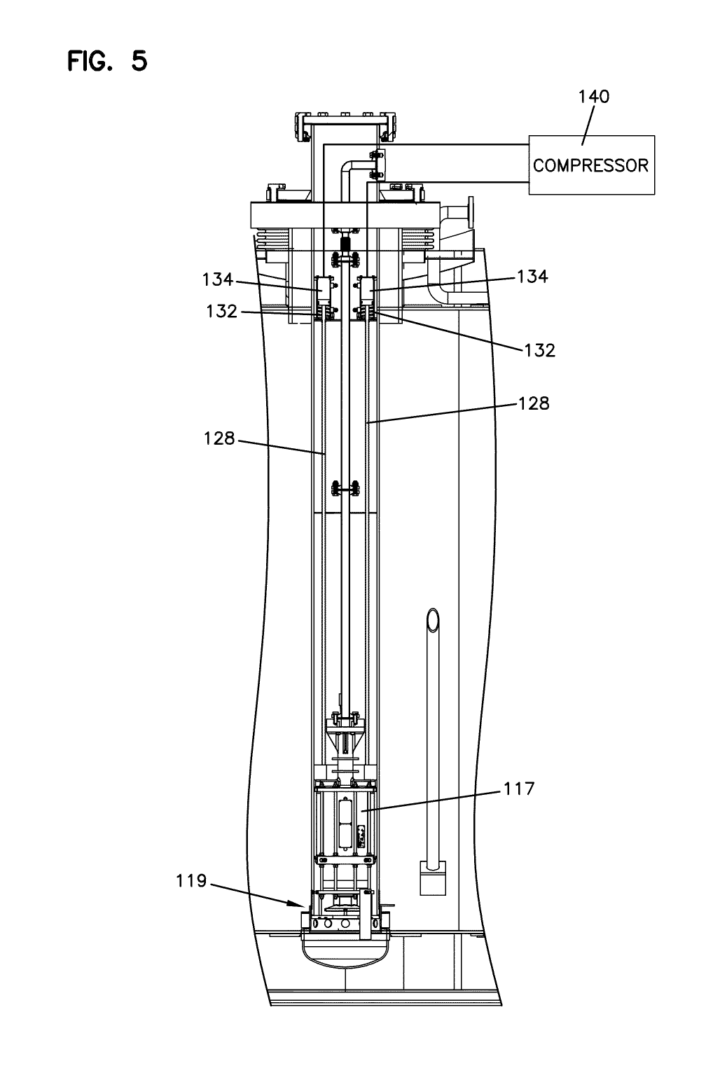

As shown in FIG. 3, attached to the lower pump housing assembly 12 is a spring loaded actuator 28. The actuator 28 is configured to move the foot valve assembly 19 between the open and the closed positions. While only one actuator 28 is shown, it is contemplated that a plurality of linear actuators could be attached to the lower pump housing assembly 12 to ensure a proper seal and fast operation. The actuator 28 can be mounted on the outside of the pump housing 26 within the storage tank 11, emerging from the storage tank 11 near the pump housing assembly's main access point 30. Specifically the actuator may be attached to the basket 22 via a sleeve 20. In other embodiments, the actuator 28 may travel up through the pump housing 26 and emerge from the tank at the upper inlet of the pump housing 26 (as shown in FIG. 5). At such a location outside of the storage tank where the actuator emerges, the actuator 28 makes up a part of the upper pump housing assembly 14.

In some embodiments, the linear actuator 28 is spring loaded so that it compensates for the weight of the foot valve assembly 19, such that, when the foot valve assembly 19 is in its rest state, the sealing plate 16 is pulled up against the seal 18. Position sensors can be added to the actuator 28 to monitor position of the sealing plate 16. In some embodiment, a manual mechanical override systems can be added to the actuator 28, such as a screw to push (or pull) the actuator 28.

FIG. 4 shows a schematic view of the upper pump housing assembly 14. The upper pump housing assembly 14 includes the single access point 30 and an actuating piston cylinder 34.

The actuating piston cylinder 34 includes an upper port 36, a lower port 38, and a spring 32. When a pressurized fluid (e.g., pressurized liquid or pressurized air/gas from the pressurized storage tank) is applied to the upper port 36, the actuator 28 acts to compress the spring 32, effectively moving the actuator 28 in a direction toward the lower pump housing assembly. Such movement of the actuator 28 causes the foot valve assembly 19 to be positioned in the open position. When pressurized fluid is removed from the upper port 36, the spring 32 forces the actuator 28 back to its resting state, thereby positioning the foot valve assembly 19 in a closed position.

The moment that the pressure required to keep the foot valve assembly 19 in the open position is no longer maintained in the actuating piston cylinder 34, the actuator 28 moves closed and the foot valve assembly 19 moves to the closed position, thereby sealing the pump housing 26 from the storage tank 11. In some embodiments, as an additional safety factor, the lines (not shown) that connect to the actuating piston cylinder 34 may be plastic, or an equivalent material with a low melting point, so that—in the event of a fire—the pressurizing lines melt, automatically releasing the pressure in the actuating piston cylinder 34, thereby moving the foot valve assembly 19 to the closed position. In other embodiments, the lower port 38 of the actuating cylinder 34 may be open to the atmosphere such that—in the event that seal 39 fails, causing LNG to leak from the inner tank 15 via an actuator shaft 41 that holds the actuator 28—no pressure can form on the spring side of the actuator piston cylinder 34. In another embodiment, the actuator 28 may be bellows sealed to further diminish the possibility of a leak.

In other embodiments, the foot valve assembly 19 uses two spring-loaded actuators. In still other embodiments, the foot valve assembly 19 uses three spring-loaded actuators. In still other embodiments, a single actuator is used that travels through a specifically designed pump. In other embodiments, more than three spring-loaded actuators may be used.

Systems where the foot valve assembly 19 of the present disclosure could be used include, but are not limited to, LNG storage tanks, hydrogen tanks, railcars, tender cars, boats, road tankers, gasoline tankers, ethylene transport containers, bulk propane tanks, and other liquid gas storage tanks, etc. In addition, it is contemplated that the present disclosure could serve as a replacement for fire valves in certain road and rail tank transport systems.

FIG. 5 shows an alternative embodiment of the present disclosure. Specifically, FIG. 5 depicts a system that includes an assembly for lowering and raising the pump within a pump housing assembly whereby, when the lowering and raising assembly fails, a foot valve assembly 119 is automatically moved to the closed position. In some embodiments, the lowering and raising of a pump 117 can be accomplished by using a plurality of actuators 128 located within the pump housing assembly 110 and attached to the pump 117. Such actuators 128 may be operated by pneumatic, hydraulic, or electric means. Additionally, in some embodiments, the actuators 128 may use actuating piston cylinders 134, which can include springs 132. When a pressurized fluid (e.g., pressurized liquid or pressurized gas/air from the pressurized storage tank) is supplied to one side of the piston cylinder 134, the pressure acts to compress the spring 132, effectively moving the actuator 128, lowering the pump 117, and moving the foot valve assembly 119 into the open position.

In the depicted embodiment, the pressurized fluid can be supplied to the piston cylinders 134 by a compressor 140. When pressurized fluid is removed, either on purpose or in the event of a failure (i.e., fire), the springs 132 force the actuators 128 back to their resting state, raising the pump 117, and closing the foot valve assembly 119. The system depicted in FIG. 5 may be implemented into cryogenic tanks that include conventional spring weight based foot valves to increase safety and easy maintenance.

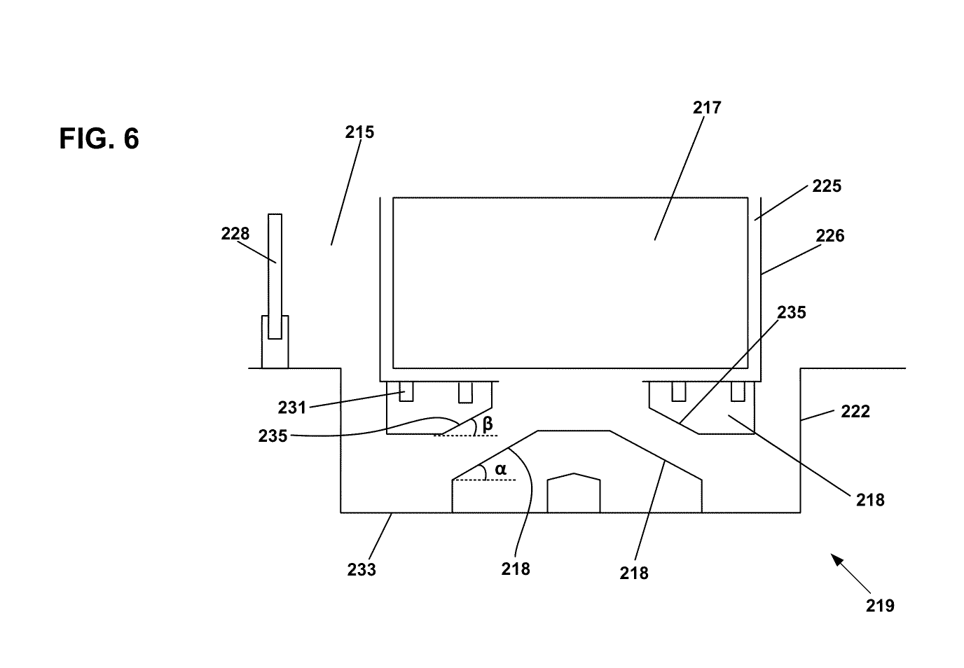

FIG. 6 shows an alternative embodiment of the present disclosure. Specifically, in the depicted embodiment, a foot valve assembly 219 is shown. The foot valve assembly operates similarly to the foot valve assembly 119, including an actuator 228, as described herein. In the embodiment shown in FIG. 6, the configuration of the sealing plate 216 and the seal 218 differ from the foot valve assembly 119.

The seal 218 is a conical seal attached to a pump housing 226. The conical seal can be made of an elastomer that retains some flexibility at cryogenic temperatures, such as Teflon®, Kevlar®, Kel-F®, Nylon®, etc. The seal 218 can be attached to the pump housing 226 by a plurality of fasteners 231. The seal is designed to make contact with the sealing plate 218 to seal the interior of the pump housing 225, specifically the pump 217, from the inner tank 215. In some embodiments, seal 218 includes an inner sloped surface 235. The sloped surface has an angle β with the ground. In some embodiments, the angle β is less than 45 degrees. In other embodiments, the angle β is between about 30 degrees and 80 degrees.

The sealing plate 216 includes sloped sealing surfaces configured to mate with the conical seal 218. In some embodiments, the slope of the contact surfaces of the seal plate are orientated at an angle α with the horizontal plate 233 of the of the basket 222. In some embodiments, angle α is less than 45 degrees. In some embodiments, the angle α is between about 30 degrees and 80 degrees. In still other embodiments, angle α and angle β are about the same.

In some embodiments, the sealing plate 216 is secured to the horizontal plate 233 of the basket 222 by a weld. In other embodiments, the sealing plate 216 and horizontal plate 233 can be a single part.

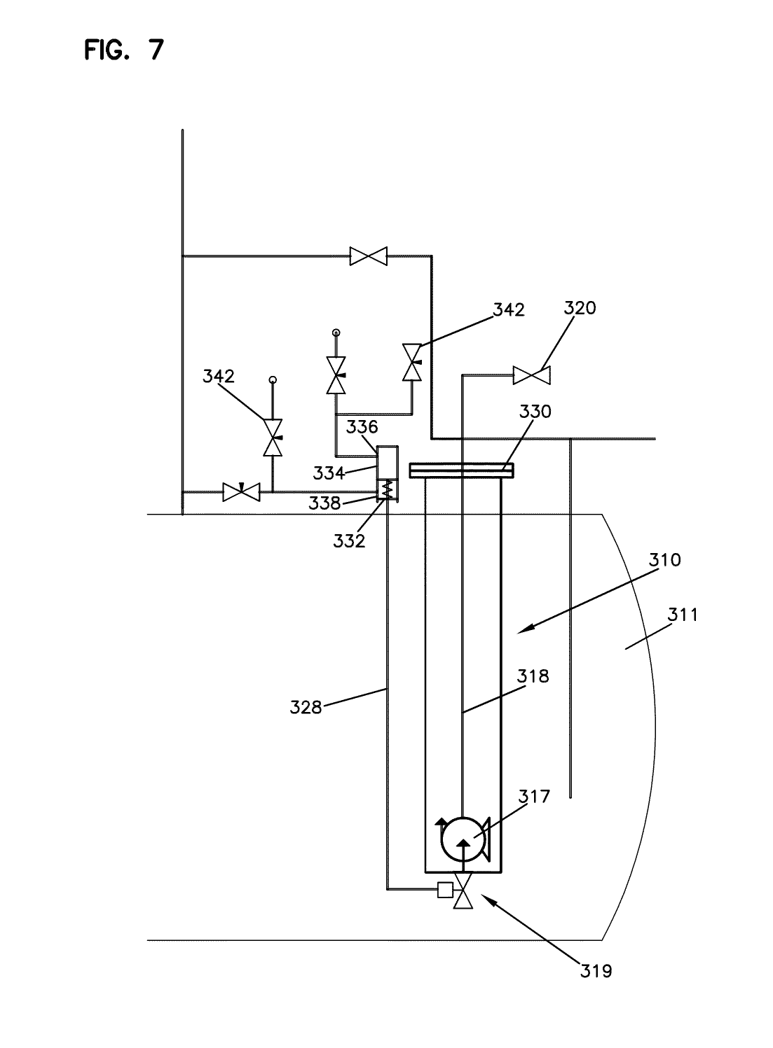

FIG. 7 shows an example of a valving schematic according to one embodiment of the present disclosure. The valving schematic depicts a tank 311 which includes pump housing assembly 310 that includes a single access point 330, shown located in the top of the tank 311. Accordingly, the pump housing assembly 310 includes a pump 317. The pump 317 can include a fluid removal conduit 318 that includes a valve 320. At the lower part of the pump housing assembly 310 is a foot valve assembly 319, attached to which is pressurized actuator 328. While only one actuator 328 is depicted, it is contemplated that a plurality of actuators could be connected to the foot valve assembly 319. The actuator 328 includes a spring 332 and an actuating piston cylinder 334 that help to facilitate the movement of the actuator 328. Pressurized fluid may be introduced to the upper port 336 or lower port 338 of the actuating piston cylinder 334 to force the actuator 328 in a certain direction, which, in turn, moves the foot valve assembly 319. The pressurized fluid may come from a variety of sources like a hydraulic pump or air compressor. Also, the upper port 336 and the lower port 338 of the actuating piston cylinder 334 can also include relief valves 342 to remove pressure from the actuating piston cylinder 334, thereby allowing each of the lower and upper ports 338, 336 to be vented to atmospheric pressure.

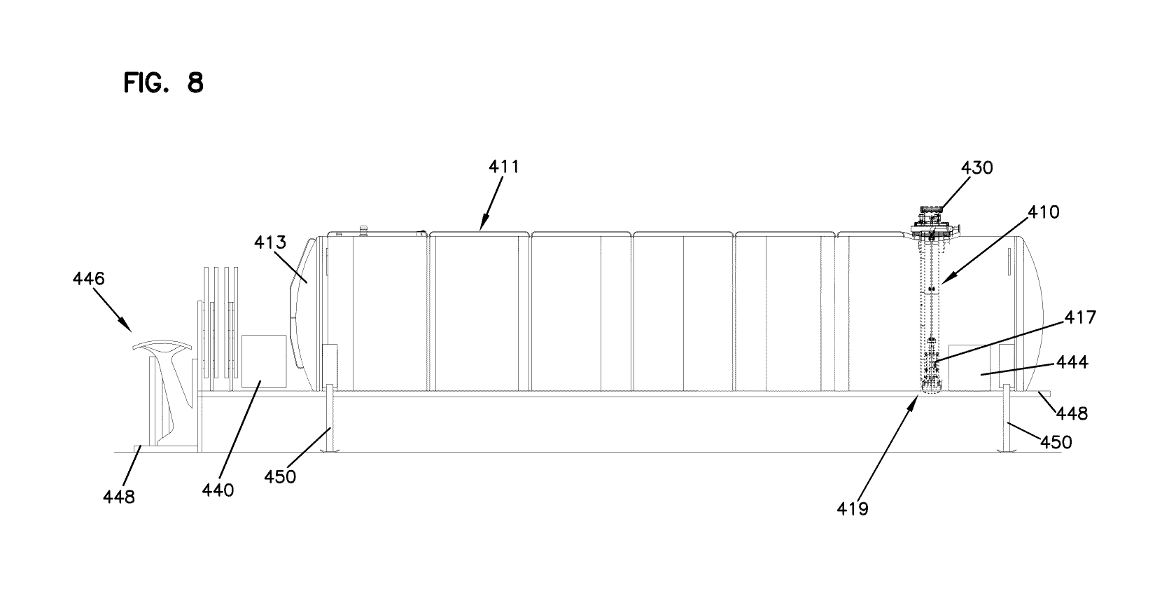

FIG. 8 shows a particular example system in which the above described foot valve assemblies could be used. Specifically, the system includes an LNG mobile dispensing system that includes a cryogenic tank 411, a prewired electrical panel 444, a compressor 440, and a dispenser 446. Additionally, in some embodiments, the whole system can be on a skid 448, or skids, and include jacks 450 to raise and lower the system on and off of a flatbed trailer. The tank 411 can have a single large penetration 430 that can include a pump housing assembly 410 which can be isolated from the tank 411 by way of a foot valve assembly 419. The pump housing assembly 410 can further include a removable pump 417 and all necessary process piping. Process piping can consist of: 1) a top fill line connected to an internal spray header, 2) a saturation return line connected to a bottom sparger header, 3) a vent line connected to a dual relief system, 4) a sendout pump line connected to the dispenser or dispensing hose, 5) a full trycock, and 6) top and bottom phase lines. Additionally, the tank 411 can be vacuum jacketed for containment, further including a stainless steel outer jacket 413 and an inner tank. The inner tank can be a 30 to 500 PSI MAWP ASME coded pressure vessel depending on application needs. Other pressure vessel codes can also be used for the vessel design. The inner tank can have two penetrations—the process penetration and the bottom phase line penetration. Insulation can be multilayer superinsulation. The Estimated NER can be about 0.10%.

Specifically, building the outer vacuum jacket of an LNG storage tank with a cryogenically stable material, such as stainless steel, provides a number of advantages. First, the design of the system is an unbroken solid stainless steel tank with no openings below the top of the inner tank. As a result, a leak or a break anywhere at all on the inner tank would still be below the maximum height of the outer vessel. Second, in the depicted embodiment, all penetrations into the outer jacket 413 are at the top of the tank so as not to provide any way for liquid to spill other than into the outer jacket containment. Third, in the event of a rupture or spill, the LNG is contained, and any gases formed through evaporation of the LNG can exit to the atmosphere only through a defined point, whose area can be as small as 3 inches to 6 inches in diameter. This vastly enhances the safety of the system, because an LNG plume would be limited to a very specific and small area. The area of plume emission is so small that conventional dry chemical fire extinguishing methods—even by amateurs—can be effective in the event of the plume igniting. In some embodiments, the outer tank 413 can hold the dispenser 446 on the front head, near the process penetration, and the electrical, hydraulic, and gas detection equipment on the rear head outside the classified area.

In some embodiments, the system in which the foot valve assembly 419 is integrated, can be a movable fueling station with certain features that lead to low life cycle costs. Such a system can include, first, a submerged multi-stage pump 417 designed to fill dedicated fuel tanks. Second, the system can include containment in the form of a dual jacket stainless steel storage tank 411. Third, the system can include automatic self-loading and unloading means 450 (i.e. jacks or extendable rails) from a standard flatbed. Fourth, the system can include a pre-wired electrical control panel 444. Fifth, the system can include a dispenser 446. Sixth, the system can be on a skid for greenfield use. Seventh, the system can include an onboard compressor 440 to activate the fail-closed foot valve assembly 419. Not all of the above features may be incorporated in all embodiments.

The mobile system can be designed such that the empty station is transported to the site and then lifted off the semitrailer with incorporated hydraulic jacks. The trailer is pulled away, and the jacks lower the station to the ground. The full length skids of the unit allow it to be used on rough ground, without cement or hard foundations. To put the unit into operation, a power supply cable with three phase 440 VAC power is connected. Pump wiring, instrument wiring, and meter wiring can be prefabricated and installed in the system at the factory. Installation and erection time of the station is estimated at four to six hours, most of which is the cool down of the vessel.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A foot valve assembly for a submergible housing comprising:
a substantially open-ended submergible housing having an interior volume;
an actuator configured to be operated by pressurized fluid; and
a sealing mechanism positioned at the open end of the submergible housing, the sealing mechanism being configured to alter fluid flow into the housing, the sealing mechanism also being attached to the actuator,
wherein the actuator is configured to move the sealing mechanism between a first position and a second position, the first position being a closed position and the second position being an open position.

2. The foot valve assembly of claim 1, wherein the open position allows fluid to flow into and out of the interior volume of the housing, and the closed position limits flow into and out of the interior volume of the housing.

3. The foot valve assembly of claim 2, wherein the closed position prevents fluid flow into, and out of, the interior volume of the housing.

4. The foot valve assembly of claim 1, wherein the actuator is spring loaded.

5. The foot valve assembly of claim 4, wherein the spring-loaded actuator positions the sealing mechanism in the closed position when no pressure is applied to the spring-loaded actuator.

6. The foot valve assembly of claim 1, further comprising a plurality of actuators attached to the sealing mechanism.

7. The foot valve assembly of claim 1, further comprising three actuators attached to the sealing mechanism, the actuators being spaced equidistant around the submergible housing.

8. The foot valve assembly of claim 1, wherein the sealing mechanism includes a sealing plate and a seal, the sealing plate being positioned to compress the seal between the submergible housing and the sealing plate when in the closed position.

9. The foot valve assembly of claim 8, wherein the sealing plate is attached to a basket, the basket having walls being substantially perpendicular to the sealing plate, and wherein the basket walls include a plurality of openings.

10. The foot valve assembly of claim 9, wherein, when the sealing mechanism is in the open position, an exterior fluid passes through the plurality of openings in the basket walls before entering the interior of the submergible pup housing.

11. The foot valve assembly of claim 8, wherein the sealing plate is shaped to be self-centering within the open end of the submergible housing.

12. The foot valve assembly of claim 8, wherein the seal is fixed to the submergible housing.

13. The foot valve assembly of claim 1, wherein the sealing mechanism includes a sealing plate and a plurality of seals, the sealing plate being positioned to compress the plurality of seals between the submergible housing and the sealing plate when in the closed position, and wherein the plurality of seals are spring energized.

14. The foot valve assembly of claim 1, wherein the actuator includes a first valve and a second valve, the first valve being adapted to accept a pressurized hose, and the second valve being adapted to vent the spring-loaded actuator to atmospheric pressure.

15. The foot valve assembly of claim 1, wherein the actuator is operated by compressed gas.

16. The foot valve assembly of claim 1, wherein the submergible housing is configured to house a submergible pump.

17. A cryogenic tank assembly comprising:
a storage container configured to be pressurized and store fluid;
a substantially open-ended submergible pump housing located within the storage container;
a pump removably located within the submergible pump housing; and
a foot valve assembly mounted to the submergible pump housing including at least one actuator and a sealing mechanism, the actuator being configured to move the sealing mechanism between a closed position and an open position,
wherein, when the sealing mechanism is in the closed position, the pump may be removed from the submergible pump housing without altering the pressure of the storage container or draining the fluid stored within the storage container.

18. The A cryogenic tank assembly of claim 17, wherein the submergible pump housing is the single entry point to the storage container and wherein the sealing mechanism is operable independently from the position of the pump.

19. A foot valve assembly for a submergible pump or other pressurizing device comprising:
a substantially open-ended submergible pump housing;
a pump removably positioned within the pump housing;
a sealing mechanism mounted at the open end of the submergible pump housing for sealing the pump housing, wherein the sealing mechanism is operated by the weight of the pump; and
an actuator movable by pressurized fluid wherein the actuator is connected to the pump and wherein the sealing mechanism is in the closed position when the actuator is not pressurized.

20. The foot valve assembly of claim 19, wherein the actuator is spring loaded.
